(19) United States
(12) Patent Application Publication
(10) Pub. No.: US 2023/0156769 A1
(43) Pub. Date: May 18, 2023

(54) DYNAMIC QOS-BASED CO-DESIGN OF WIRELESS EDGE-ENABLED AUTONOMOUS SYSTEMS WITH MACHINE LEARNING

(71) Applicants: Mark Eisen, Beaverton, OR (US); Amit Baxi, Thane (IN); Dave Cavalcanti, Portland, OR (US); Ramya M, Erode (IN); Santosh Shukla, Bengaluru (IN)

(72) Inventors: Mark Eisen, Beaverton, OR (US); Amit Baxi, Thane (IN); Dave Cavalcanti, Portland, OR (US); Ramya M, Erode (IN); Santosh Shukla, Bengaluru (IN)

(21) Appl. No.: 18/153,913

(22) Filed: Jan. 12, 2023

(51) Int. Cl. H04W 72/543; H04L 41/16; H04W 72/53

(52) U.S. Cl. CPC H04W 72/543; H04L 41/16; H04W 72/53

(57) ABSTRACT

This disclosure describes systems, methods, and devices related to providing dynamic quality of service (QoS) to multiple devices using QoS-aware controls. A device may identify first state information from a first device using the network and second state information from a second device using the network; generate, using machine learning, based on the first state information, a first dynamic QoS to be applied to the first device at a first time, and, based on the second state information, a second dynamic QoS to be applied to the second device at the first time; allocate a first allocation of resources to the first device, based on the first dynamic QoS, at the first time; and allocate a second allocation of resources to the second device, based on the second dynamic QoS, at the first time.

### TECHNICAL FIELD

This disclosure generally relates to systems and methods for wireless communications and, more particularly, to dynamic quality of service (QoS)-based co-design of wireless edge-enabled autonomous systems with machine learning.

### BACKGROUND

Wireless devices are becoming widely prevalent and are increasingly requesting network resources.

### BRIEF DESCRIPTION OF THE DRAWINGS

FIG. 1 is a network diagram, in accordance with one or more example embodiments of the present disclosure.

FIG. 2 illustrates an example edge-enabled industrial control system, in accordance with one or more example embodiments of the present disclosure.

FIG. 3 illustrates example wireless edge control systems, in accordance with one or more example embodiments of the present disclosure.

FIG. 4 shows example co-design learning processes for edge control systems, in accordance with one or more example embodiments of the present disclosure.

FIG. 5 shows example series of wireless control loops, in accordance with one or more example embodiments of the present disclosure.

FIG. 6 illustrates an example information flow between two devices at a shared edge for a co-designed quality of service (QoS)/control policy, in accordance with one or more example embodiments of the present disclosure.

FIG. 7 illustrates an example machine conveyor belt digital twin environment used for training and evaluation of a co-designed QoS/control policy, in accordance with one or more example embodiments of the present disclosure.

FIG. 8 shows a graph of percent of objects lifted using the machine conveyor belt digital twin environment of FIG. 7 when dynamic QoS and static QoS are used, in accordance with one or more example embodiments of the present disclosure.

FIG. 9 illustrates a flow diagram of illustrative process for an illustrative dynamic QoS system, in accordance with one or more example embodiments of the present disclosure.

FIG. 10 illustrates a functional diagram of an exemplary communication station that may be suitable for use as a user device, in accordance with one or more example embodiments of the present disclosure.

FIG. 11 illustrates a block diagram of an example machine upon which any of one or more techniques (e.g., methods) may be performed, in accordance with one or more example embodiments of the present disclosure.

FIG. 12 is a block diagram of a radio architecture in accordance with some examples.

FIG. 13 illustrates an example front-end module circuitry for use in the radio architecture of FIG. 12, in accordance with one or more example embodiments of the present disclosure.

FIG. 14 illustrates an example radio IC circuitry for use in the radio architecture of FIG. 12, in accordance with one or more example embodiments of the present disclosure.

FIG. 15 illustrates an example baseband processing circuitry for use in the radio architecture of FIG. 12, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Controlling internet of things (IoT), machine systems, and other autonomous time-sensitive devices and systems using a wireless network may be difficult due to network resources needed, latency, scaling (e.g., accommodating more devices using the network), channel noise, packet loss, and the like. Quality of service (QoS) requirements may be applied to a network to ensure sufficient performance, and QoS requirements may be specific to time-sensitive autonomous control systems. For example, QoS requirements may provide limits for latency, channel noise, packet loss, and the like to facilitate sufficient performance of the devices in a network. QoS specifications exist for time-sensitive networking (TSN) and for ultra reliable low latency communications (URLLC), but such QoS specifications are static (e.g., do not change based on network conditions and device needs).

One approach for ensuring performance of autonomous control systems is a co-design framework for autonomous control systems and wireless networks. Co-designing allows for designing control policies for systems to be robust against a wireless network to correct against communication delays and information loss. Co-design may allow a network to opportunistically utilize resources where they are most needed. For example, a machine system that needs data more quickly than another system may receive more network resources than the other system due to a co-design framework.

There is considerable interest in determining how to maintain both strong autonomous control system and wireless network performance in these settings. Wireless networks in particular, including the latest wireless technologies such as 5G and Wi-Fi 6, rely on resource allocation optimizations to meet performance targets. Many radio resource allocation schemes in the form of wireless scheduling techniques have been proposed to provide quality of service (QoS) to users across the network in the form of throughput, fairness and/or latency. For time-sensitive applications, delay-aware schedulers such as earliest deadline first (EDF) and weighted fair queuing (WFQ) are often utilized. These methods, however, may ignore the underlying needs of the control system applications they are intended to support. Some other methods allocate wireless resources based on the state of the control system in a manner that maximizes control system performance.

In larger scale systems, there may not be enough wireless network resources to provide high levels of QoS to all control systems all the time. It may not be practical to allocate enough spectrum resources to meet strict QoS needs of all control systems all the time in large scale deployments. Not only must resource be prioritized based on need across control systems, but the autonomous control systems themselves must be capable of operating successfully under lower levels of QoS. The best possible performance in these settings come when the network and computing resource allocation polices and control policies are co-designed, or jointly optimized with respect to one another.

Communication/control co-design problems have been formulated as joint optimization problems that maximize both network efficiency and control system performance. Existing approaches to these problems are limited due to i) their reliance on accurate system models and (ii) optimization complexity that arises from resource allocation. These limitations make it challenging to apply existing methods to practical systems in realistic communication networks.

In one or more embodiments, in the present disclosure, the above problems are addressed by a method to optimize network and control system performance based on a quality of service (QoS) measure that is locally and dynamically adapted using a modular machine learning approach. The QoS-based approach towards co-design make the optimization problem simpler, more scalable, and easily utilized across various network protocols (e.g. WiFi, 5G). The modular machine learning architecture facilitates the learning of complex behavior through a sequence of simpler machine learning problems that can be independently solved using various ML approaches (e.g. supervised learning, RL, numerical optimization).

Wireless control systems can be designed to operate in close to ideal conditions by maintaining ultra-reliable and low latency communications (URLLC) and TSN (Time-sensitive networking) capabilities in wireless networks, such as 5G and Wi-Fi 6. The URLLC performance is obtained in the network through overprovisioning of resources, traditional control methods can be used in this case.

Some control/communications co-design problems are solved using model-based analysis and heuristics for simple systems (e.g. linear control systems and event-triggered communications). Reinforcement learning has been used to solve resource allocation problems in power control and OFDMA settings to optimize communication-based metrics (e.g. throughput).

URLLC communications and TSN require significant overprovisioning of wireless resources (e.g. bandwidth, time, redundant links) to maintain ultra-reliability and low latency, which can come at significant cost. This moreover may not be possible in large-scale and resource-constrained settings.

Model-based control/communication co-design is limited in its applicability to simple systems, such as linear plants. These algorithms are therefore not practical in realistic industrial use cases, such as machines, that exhibit nonlinear dynamics. There do not exist machine learning-based solutions that allow for co-design of control and communication policies in nonlinear systems and modern OFDMA-based communication networks (e.g. 5G, Wi-Fi 6).

Current co-design techniques may not be scalable or dynamic to account for a dynamic QoS that may allow for network performance that may not satisfy a worst-case QoS.

In one or more embodiments, the present disclosure proposes two mechanisms to co-design autonomous control systems and wireless networks, including (i) a learning-based state estimator that corrects inaccurate control system state information resulting from delayed or dropped packets and (ii) a dynamic QoS calculation/request to adapt minimum network QoS requirements based on the current control state. For the latter case, ensuring that the QoS of each flow can be met may be the job of a network scheduler, for example, an access point (AP) or Fifth Generation (5G) base station, and may require that the network has enough overall capacity to meet such requirements. The requirement also may be true in a traditional network design, where the network capacity must be sufficient to meet high levels of QoS at all times for all flows. In the scheme, however, such network capacity needed to meet DYNAMIC QoS requirements may be lower, and thus more resource efficient, than the capacity requirements needed in traditional wireless networks to meet a worst-case static QoS requirements. The degree to which the dynamic requirements may be lower than a worst-case QoS will depend on the particular autonomous system and it is another novel contribution of this disclosure to identify what those minimum QoS requirements are for a given system.

In one or more embodiments, the dynamic QoS requirements described in the present disclosure may be calculated based on the current control device state (e.g. autonomous device position, recent performance measurements, position, velocity, etc.), so therefore control systems operating at different states will not all simultaneously require the same QoS from the network, protecting against the worst case scenario. Both theoretical and machines simulations have demonstrated that these control-based QoS requirements are often less strict than traditional worst-case QoS requirements (e.g. 0.9999 reliability). By optimizing the QoS more resource efficient configurations are identified that allow multiple control systems to operate in the same network with less capacity than would be otherwise required to always maintain worst-case QoS requirements. This is a different paradigm from current designs, but the emerging technologies in this space, such as virtualization and convergence of IT/OT may require a change in the current design to operate more efficiently and at larger scales. The proposed enhancements herein are tools that can enable more dynamic optimization of the network resources compared to the current worst-case design approach. The dynamic QoS approach described herein may be used for control systems that can afford less strict requirements and still function as needed.

In one or more embodiments, because the theoretical optimization problem to perfectly optimize dynamic QoS requirements for practical systems (e.g. machines) is intractable, machine learning (ML) may be used as a heuristic approximation to those optimal solutions. ML-based dynamic QoS policies may be tested and validated prior to deployment, both in simulation and in physical deployment offline. In addition, additional protective measures can be put in place on top of the ML decision making layer to ensure proper operation in practice (e.g. increase ML-based QoS output by 15%, adding stopgap measures to prevent system from entering critical states) while still increasing efficiency relative to the traditional high-reliability network.

In one or more embodiments, due to both the high sample complexity and safety concerns of reinforcement learning (RL) algorithms, it may be preferable to perform some of the RL training offline prior to system deployment. Training may be performed by a simulation platform (e.g. machines simulator/Digital Twin) so that critical states experienced during learning do not impact actual system operation.

In one or more embodiments, the enhanced methods jointly optimize both the QoS-aware adaptation of an application and application-aware adaptation of QoS requirements to maximize performance and efficiency in resource constraint systems. The present disclosure further details a modular machine learning method that makes the co-design solution tractable in complex autonomous systems (e.g. machines).

In one or more embodiments, a dynamic QoS system may define a novel method to enable control-communication co-design optimizations for wireless control systems based on network-level quality of service (QoS). The method consists of locally maintaining two jointly designed policies for operation of a control system (or cyberphysical system): (1) a dynamic QoS policy to determine minimum QoS requirements at current operation state and (2) a QoS-aware cyberphysical state estimation that determines the current state given a received state and network-level QoS.

In one or more embodiments, a dynamic QoS system may define an information flow between Edge infrastructure (e.g. Wi-Fi AP, 5G gNBs, and Mobile Edge Computing—MEC) and device, so that the method can be applied to a large collection of multiple cyberphysical control loops. Each cyberphysical device uses its received state information to make a QoS service request, e.g. latency, reliability, from the Edge/Network controller (or scheduler), which may be running on an Edge computing infrastructure. This information is signaled to the Edge controller, which then makes resource allocation decisions to meet the QoS needs to multiple systems. The plant state information, e.g. position, velocity, is sent from the Edge to the devices with a provided QoS to estimate the current state and take appropriate control actions.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

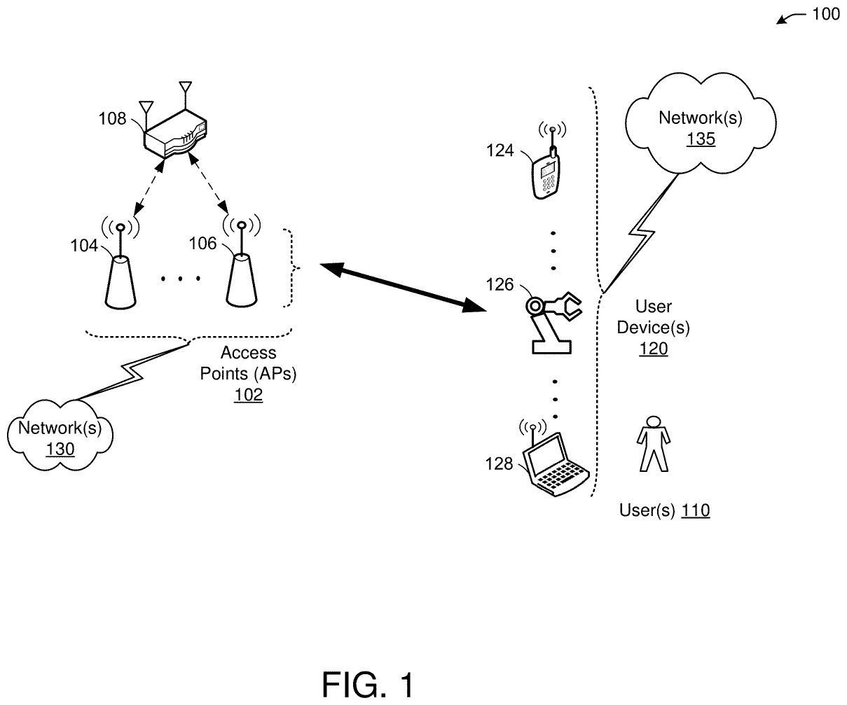

FIG. 1 is a network diagram, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

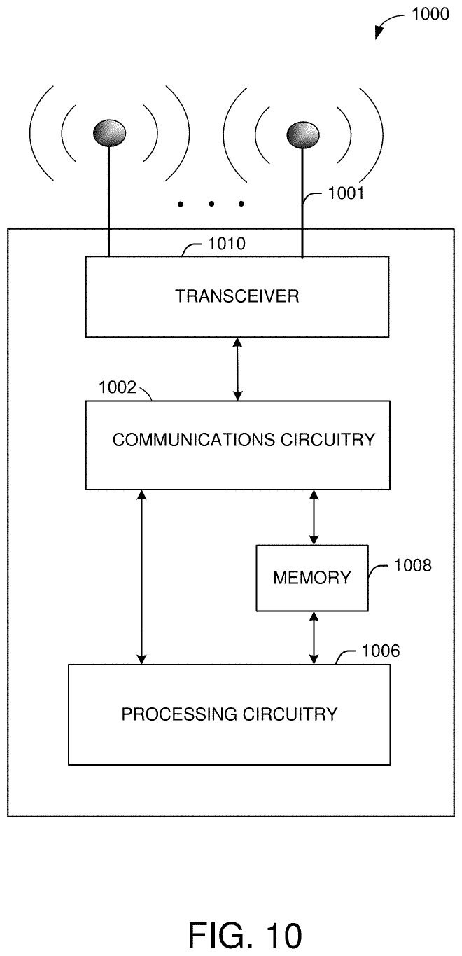

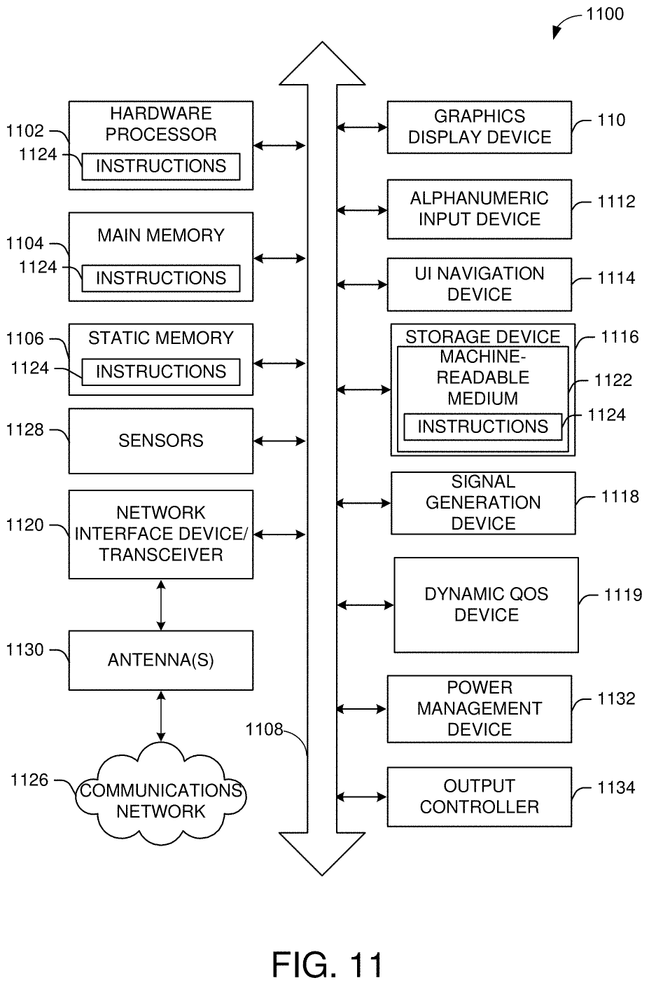

In some embodiments, the user devices 120 and the AP 102 may include one or more computer systems similar to that of the functional diagram of FIG. 10 and/or the example machine/system of FIG. 11.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

In one or more embodiments, a controller 108 (e.g., a wireless TSN controller) may facilitate enhanced coordination among multiple APs (e.g., AP 104 and AP 106). The controller 108 may be a central entity or another AP, and may be responsible for configuring and scheduling time sensitive control and data operations across the APs. A wireless TSN (WTSN) management protocol may be used to facilitate enhanced coordination between the APs, which may be referred to as WTSN management clients in such context. The controller 108 may enable device admission control (e.g., control over admitting devices to a WTSN), joint scheduling, network measurements, and other operations. APs may be configured to follow the WTSN protocol.

In one or more embodiments, the use of controller 108 may facilitate AP synchronization and alignment for control and data transmissions to ensure latency with high reliability for time sensitive applications on a shared time sensitive data channel, while enabling coexistence with non-time sensitive traffic in the same network.

In one or more embodiments, the controller 108 and its coordination may be adopted in future Wi-Fi standards for new bands (e.g., 6-7 GHz), in which additional requirements of time synchronization and scheduled operations may be used. Such application of the controller 1 108 may be used in managed Wi-Fi deployments (e.g., enterprise, industrial, managed home networks, etc.) in which time sensitive traffic may be steered to a dedicated channel in existing bands as well as new bands.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, etc.), 6 GHz channels (e.g., 802.11ax, 802.11be, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, AP 102 may facilitate dynamic QoS 142 with one or more user devices 120.

It is understood that the above descriptions are for purposes of illustration and are not meant to be limiting.

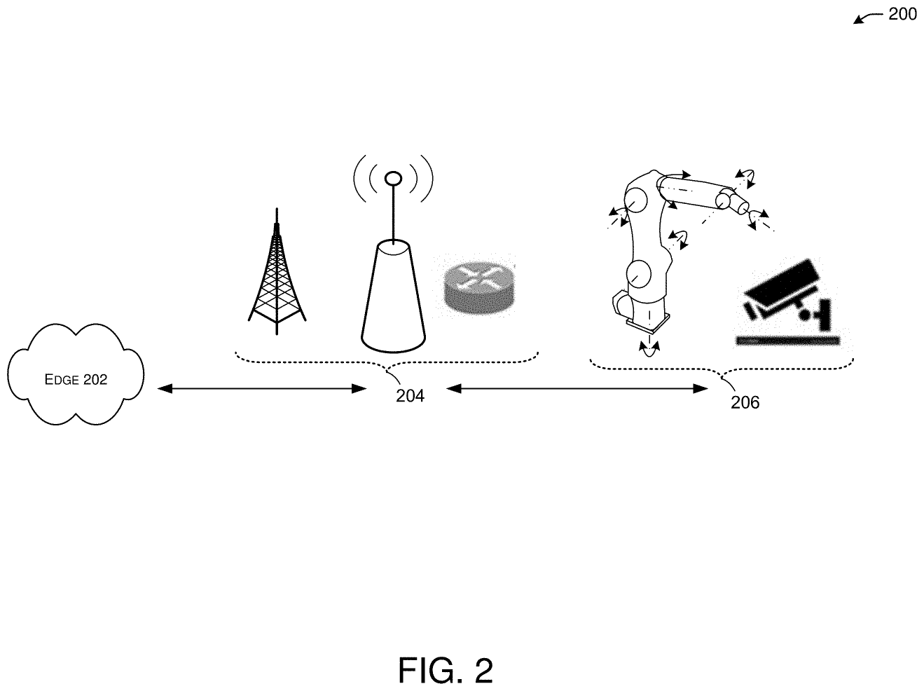

FIG. 2 illustrates an example edge-enabled industrial control system 200, in accordance with one or more example embodiments of the present disclosure.

Referring to FIG. 2, the system may include a network edge 202 in communication with communication infrastructure 204 (e.g., access points, gNBs, switches, relays, etc.) and field devices 206 (e.g., autonomous devices, cameras, sensors requiring a QoS for time-sensitive operations). The field devices 206 may offload compute heavy functions (e.g. vision, AI, control) to the network edge 202 over a communication network using the communications infrastructure 204.

A vision for the future of autonomous IoT systems, in particular industrial fixed and mobile machine systems, features a new level of autonomy through Edge computing systems that allow for both the offloading of heavy compute tasks from the device to edge, as well as a means of enabling centralized collaboration between devices. This paradigm creates a significant opportunity to address the machines and edge market opportunities in this space through products in clients (e.g. autonomous devices), infrastructure (5G or Wi-Fi network), and edge compute. Modern industrial IoT systems, however, are facing a significant challenge in i) designing autonomous control systems that can operate under the delays and packet loss inherent in wireless networks, and ii) optimizing wireless communication networks for connecting devices to the Edge at the scale that is envisioned in future factories while meeting the strict latency and reliability requirements of autonomous systems. This has motivated the development of end to end wireless control system technology that can achieve reliable performance in these settings. Wireless networks, however, contain a significant amount of noise when compared to wired counterparts, regardless of the spectrum used. As the systems scale and wireless resources become limited, the performance of wireless control systems can degrade significantly or become unstable.

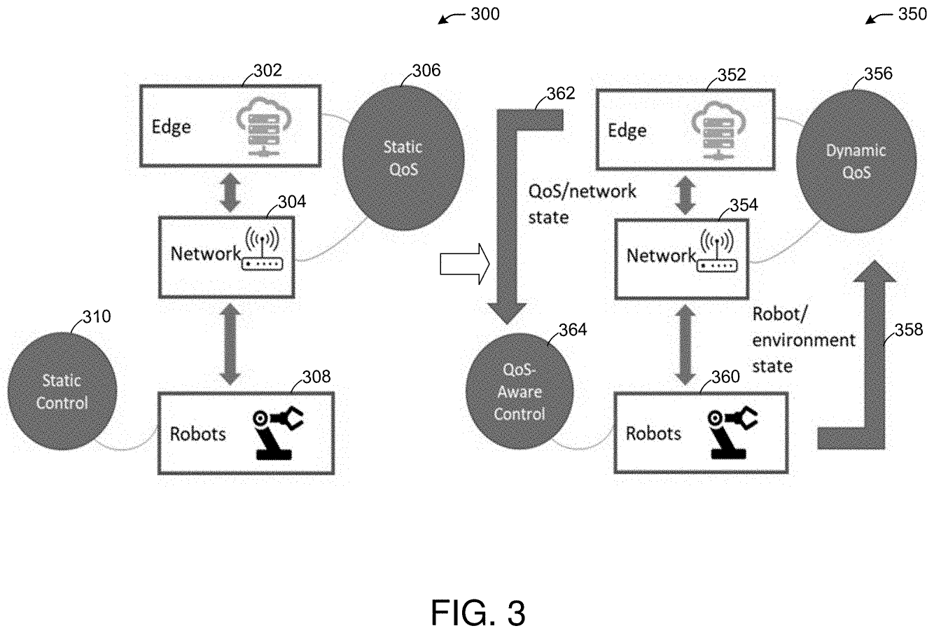

FIG. 3 illustrates example wireless edge control systems, in accordance with one or more example embodiments of the present disclosure.

Referring to FIG. 3, a wireless edge control system 300 may include a network edge 302 communicating with a network 304 to implement a static QoS 306 for devices 308 (e.g., autonomous devices, etc.) that may use a static control 310. A wireless edge control system 350 may include a network edge 352 communicating with a network 354 to implement a dynamic QoS 356 based on autonomous device/environment state information 358 provided by devices 360. QoS/network state information 362 may be provided by the network edge 352 to a QoS-aware control 364 used by the devices 360.

In the wireless edge control system 300, state of the art features separate and local optimization of each component, whereas the wireless edge control system 350 provides a co-design interface and policies, and uses an information exchange between layers to improve performance and efficiency.

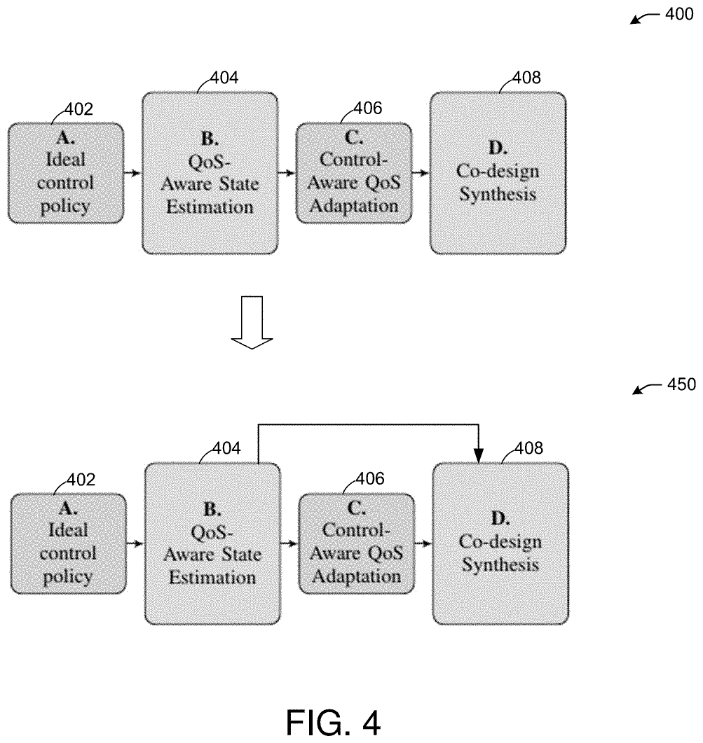

FIG. 4 shows example co-design learning processes for edge control systems, in accordance with one or more example embodiments of the present disclosure.

Given the complexity of the co-design optimization problem and lack of model availability, a modular machine learning based approach is proposed that sequentially learns smaller pieces of the co-design solution using various ML techniques (i.e. reinforcement learning and supervised learning). Referring to FIG. 4, a co-design learning process 400 may include an ideal control policy 402 used for QoS-aware state estimation 404, a control-aware QoS adaptation 406, and a co-design synthesis 408. A co-design learning process 450 may allow the QoS-aware state estimation 404 for the co-design synthesis 408. Learning sub-problems are solved in sequence using either reinforcement learning (A, C, D) or supervised learning (B). In this manner, the blocks A-D (corresponding to the ideal control policy 402, the QoS-aware state estimation 404, the control-aware QoS adaptation 406, and the co-design synthesis 408, respectively) each may use ML techniques.

The QoS-based formulation of co-design is a more scalable solution then existing resource allocation-based co-design problems in large scale cyberphysical systems (e.g. factories, warehouses, enterprises, etc.), as the local policies of each control system can be optimized independently.

The dynamic QoS approach allows the user to identify and utilize more resource efficient QoS requirements for a particular system/task that may be lower than traditional high reliability requirements.

The proposed machine learning framework allows for the breakdown of complex design problem into smaller, more tractable components. Moreover, the modularity allows for a combination of multiple ML techniques and potentially model-based techniques to be utilized in the end-to-end design.

The proposed innovations can be used in products across new wireless clients, infrastructure, (e.g. 5G, Wi-Fi 6) and edge computing technologies to ensure efficient and autonomous operation in real large scale scenarios. These products are being developed by IOTG and NPG business groups with emphasis on addressing the machines and edge market opportunities.

Wireless industrial systems are modeled as a series of autonomous control loops between a sensor, an edge computational processor, and a “plant”, or device. The sensors send sensor data to the edge processor, where contextual state information, such as position, velocity, etc., is extracted through a computational process. The state information x is sent to the devices, or plants, and used for the plants to determine their proper actuation. The control loops are closed over a shared wireless medium, which is subject to packet loss and delays. The information received by the plant, called the observation, is denoted as y. The autonomous system dynamics can be broadly defined as:

xₜ₊₁=ƒ(xₜ,uₜ)+wₜ

yₜ=g(xₜ,uₜ)

uₜ=h(xₜ,uₜ)

In the above expressions, generic nonlinear functions f, g, and h, are used to define the dynamical model, observation model, and control actuation policy, respectively. Moreover potential random noise is given as w. In the wireless autonomous system setting, these functions respectively specify a machine kinematic model, wireless delay model, and autonomous control policy.

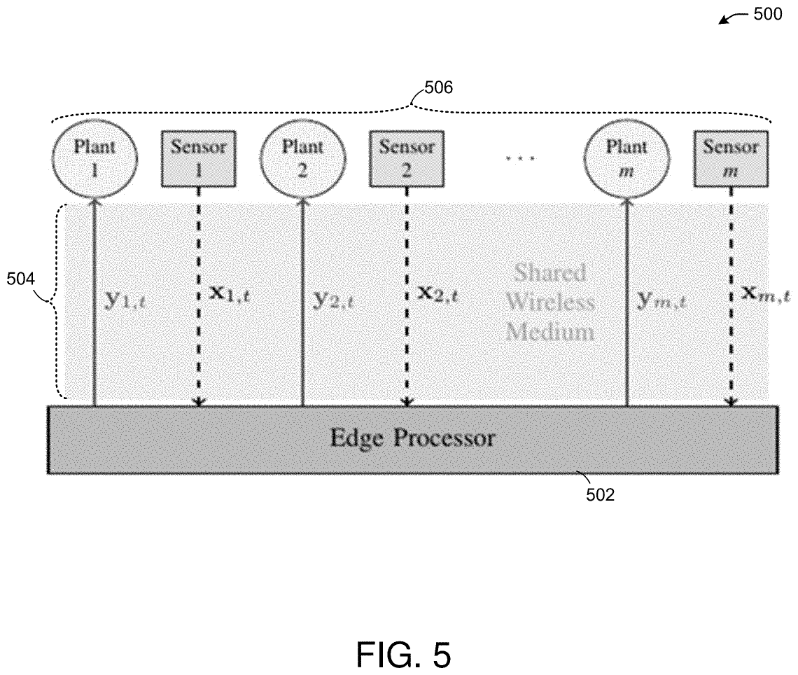

FIG. 5 shows example series of wireless control loops 500, in accordance with one or more example embodiments of the present disclosure.

Referring to FIG. 5, an edge processor 502 may use a shared wireless medium 504 to communicate with multiple systems 506 (e.g., plants 1-m, sensors 1-m, etc.). Each loop consists of a sensor that sends state information over the shared wireless medium 504 to the edge processor. The edge processor 502 transmits observations to cyberphysical devices, or plants (e.g., the systems 506).

The magnitude of the delay and probability of packet loss, called reliability, of the wireless transmissions are called the quality of service (QoS) provided to a particular control loop. The QoS of the various control loops are determined by dynamic channel conditions as well as the amount of resources (e.g. bandwidth, time, antennas) allocated to the associated transmissions.

For large-scale systems, there will generally not be enough shared resources to provide high QoS (e.g. low latency and high reliability) to all control loops at all times. In the present disclosure, it is described (a) how to properly manage the QoS requested by each device and (b) how to adapt the actuation, or control, policy used by each device in response to varying QoS, in a manner that maximizes network and resource efficiency while maintaining reliable control system performance. To describe the details of the present disclosure, the following notation are used to reflect the policies, or functions, used by device i to determine its requested QoS and control action, respectively:

[Latencyᵢ,Reliablityᵢ]=πᵢ(yᵢ;θᵢ)

ControlAction=uᵢ(yᵢ,Latencyᵢ,Reliabilityᵢ;ρᵢ)

The function πᵢ(yᵢ;θᵢ) has a predetermined form (e.g. neural network) that is fully specified by a parameter vector θᵢ, (e.g. interlayer weights in neural network). Given an input the observation yᵢ, device i uses this policy to determine its requested latency and reliability to be used for the next sequence of data packets. Moreover, the device maintains a control policy uᵢ(yᵢ, Latencyᵢ, Reliabilityᵢ; ρᵢ) that is parameterized by pi and uses the observation and measured QoS information to determine its control action.

One purpose of the present disclosure is to determine precisely how to design both the dynamic QoS and control policies jointly in a manner that maximizes system efficiency. This corresponds to determining optimal policy parameters θᵢ and ρᵢ for all control loops using the following program:

$$\{ {θ}_{i}^{q *} , {p}_{i}^{t *} \} := arg min E \{ {\sum }_{t = 0}^{T} [ {C}_{i} ( {π}_{i} ( {y}_{i , t} ) ) + λ {L}_{i} ( {x}_{i , t} ) - λ {J}_{i}^{max} / T ] \}$$

The above expression signifies that the optimal parameters are those that minimize the expected long-term cost of a set of dynamic QoS requests and corresponding control actions. The cost is a combination of a cost of requesting high QoS, given by a cost function Cᵢ(πᵢ(y_{i,t})), as well as the cost of the control plant operating in state x_{i,t}, given by Lᵢ(x_{i,t}). What is denoted by A is a weight parameter that balances QoS cost with control cost, and Jᵢ^{max} as the maximum control cost that can be tolerated for proper operation of the system. This above expression is coined the QoS-based codesign problem because it jointly optimizes the communication network and control systems in terms of a high level QoS metric. The cost function Cᵢ(π₁(y_{i,t})) cannot simply be minimized, as doing so would reduce QoS requirements below a desirable system performance needed to facilitate time-sensitive operations. In this manner, the QoS may be optimized to ensure sufficient QoS controls while minimizing the cost function to ensure such controls. Unlike some existing solutions, the present disclosure allows for multiple users of a network at a same time, and different devices of the network may have different QoS requirements at the same time.

Referring back to FIG. 4, the ideal control policy 402 and the QoS-aware state estimation 404 may be learning processes for the control policy uᵢ, and the control-aware QoS adaptation 406 and the co-design synthesis may be learning processes for a QoS Tri of an i-th device. To solve for uᵢ, the cost function Cᵢ(πᵢ(y_{i,t})) may be minimized using the ideal control policy 402 learning process, and integrated based on corrections provided by a control state estimated by the QoS-aware state estimation 404 for the QoS (e.g., using supervised learning). The control-aware QoS adaptation 406 may use RL to optimize the QoS to minimize the cost function. The co-design synthesis 408 may provide further refinement of the policies.

This formulation of the co-design problem is distinct from control-communication codesign problems in prior art because it does not directly decide the resource allocation decision of the wireless networking device, e.g. AP. The proposed formulation is preferable for complex industrial systems because the optimization of modern OFDMA-based systems is often computationally intractable and does not scale to large systems. The QoS-based approach, however, is computationally simpler because it only selects latency and reliability request which can be used by the networking managing device to make resource allocation decisions. This method is also inherently scalable because it allows the QoS and control policies to be independently optimized for each control loop.

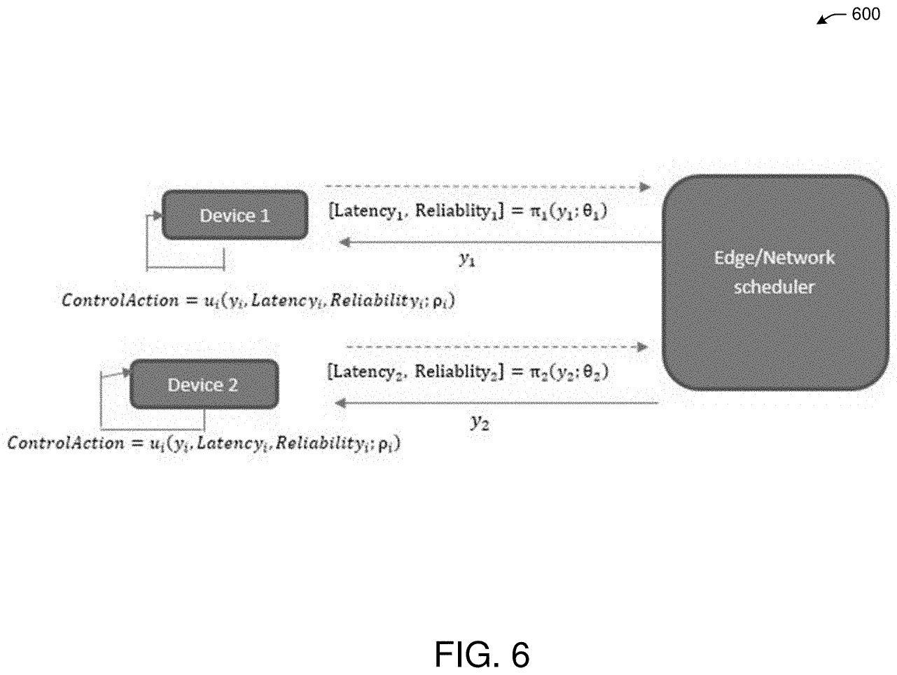

FIG. 6 illustrates an example information flow 600 between two devices at a shared edge for a co-designed quality of service (QoS)/control policy, in accordance with one or more example embodiments of the present disclosure.

The policies operate at the device and will result in the information flow 600, which may include:

1. Device (e.g., device 1, device 2) uses a received observation y (e.g., received from the edge) to determine dynamic QoS requests via πᵢ(yᵢ; θᵢ).

2. Device signals QoS request to network manager/scheduler located at Edge.

3. Edge sends next observation y to device with QoS parameters Latencyᵢ, Reliablityᵢ.

4. Device uses observation y and measured QoS for control actuation uᵢ(yᵢ, Latencyᵢ, Reliabilityᵢ; ρᵢ).

5. Repeat.

Devices uses observation information to compute dynamic QoS requests, which are signaled to Edge/AP (dashed line). The Edge processes data from sensors and sends state info back to device with given QoS (solid line). Devices use observation information and QoS measures to compute a control actions.

Machine Learning-based Co-Design.

In the present disclosure, the use of a modular machine learning method is used to solve the QoS-based codesign optimization problem. Machine learning methods are valuable in this setting because:

a) They allow for finding optimal policy parameters, (e.g. neural network weights) without access to explicit mathematical models for the control and communication system-often unavailable in practical deployments.

b) The dynamic QoS and control policies can be optimized in an online manner during system operation. That is, system feedback during operation is used to further optimize the policies in a manner that improves the cost of operation.

Due to the complexity of industrial control systems and the non-convexity of learning, using ML methods to directly solve the co-design optimization problem provided above may not lead to good results. The ML approach utilized in this disclosure breaks down the co-design problem into four separate learning problems, each of which can be solved using independent learning algorithms.

The first stage involves the learning of an ideal control policy denoted by CONTROL(y). The ideal control policy is the optimal actuations used for the plant under ideal conditions, i.e. no delay or packet loss. This is the most common form of control design, and may be solved using model-based methods (e.g. LQR control), rule-based methods (e.g. machines), or reinforcement learning by optimizing the control cost Lᵢ(x_{i,t}). This stage is typically done offline, or before system operation.

The second stage designs a QoS-aware estimator, or state correction network CORRECTION(y, Latency, Reliability). The estimator takes the received state y and measured QoS Latency and Reliability, and makes an estimate of the current state x. This stage can be completed using reinforcement learning or supervised learning by periodically collecting samples of the received state under random QoS and comparing against the true state using a Mean Square Error loss.

The third state designs the Control-Aware QoS adaptation QoS(y), which takes as input the state and minimizes the combined cost Cᵢ(πᵢ(y_{i,t}))+λLᵢ(x_{i,t})−λJᵢ^{max}/T] using reinforcement learning.

The final stage involves a synthesis of the pre-trained CORRECTION and QoS policies for joint performance maximization. For synthesis, both policies are simultaneously updated using reinforcement learning methods on the combined cost Cᵢ(πᵢ(y_{i,t}))+λLᵢ(x_{i,t})−λJᵢ^{max}/T].

It may be necessary to properly validate the quality of the learned policies prior to system operation (e.g. in simulation) to ensure sufficient performance. Additional stopgap measures should also be used in physical deployment to override the ML-based decisions when approaching critical states. Safe reinforcement learning methods may also be used to ensure safe operation during the learning process.

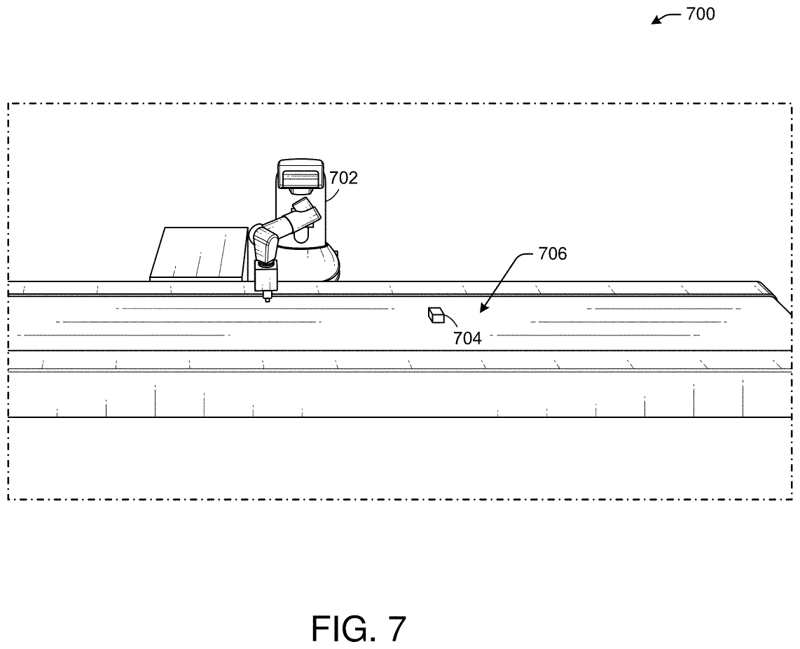

FIG. 7 illustrates an example machine conveyor belt digital twin environment 700 used for training and evaluation of a co-designed QoS/control policy, in accordance with one or more example embodiments of the present disclosure.

Referring to FIG. 7, the autonomous device 702 may pick up objects (e.g., object 704) from a conveyer belt 706 as the conveyer belt 706 moves the objects toward the autonomous device 702. In this manner, the autonomous device 702 may require a network QoS to be controlled in a time-sensitive manner to ensure that the autonomous device 702 receives proper control instructions to pick up the object 704 as the object 704 moves.

The co-design methodology may be tested on an industrial machines use-case of a machine pick and place task on a conveyor belt as shown in the twin environment 700. We are building a Digital Twin environment that combines machine simulation software with a WiFi 802.11ax simulator to evaluate the performance of a set of conveyor belt autonomous devices in a factory environment.

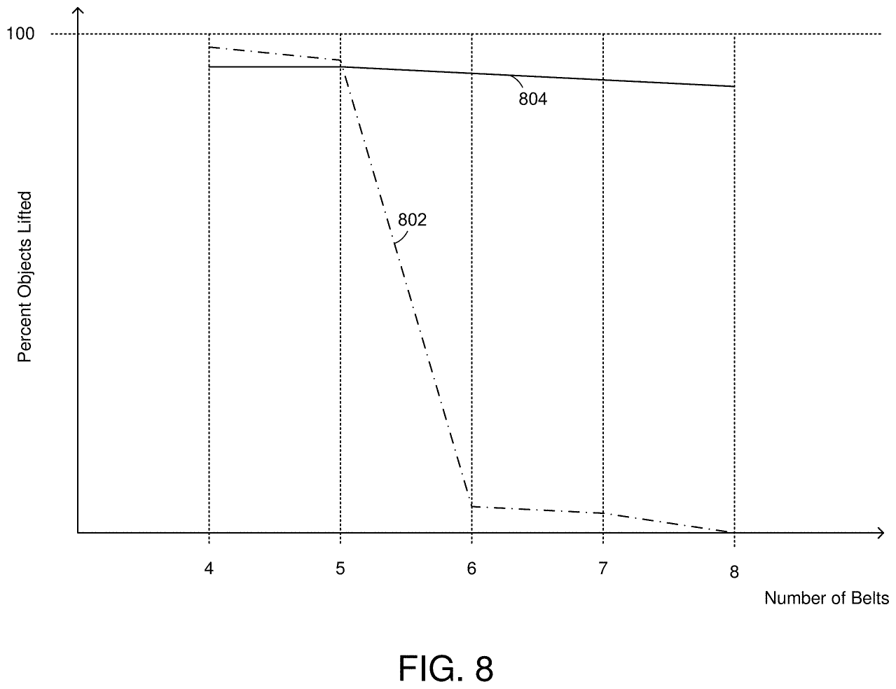

FIG. 8 shows a graph 800 of percent of objects lifted using the machine conveyor belt digital twin environment 700 of FIG. 7 when dynamic QoS and static QoS are used, in accordance with one or more example embodiments of the present disclosure.

Referring to FIG. 8, the average task success rate is demonstrated when multiple conveyor belt autonomous devices share a 40 MHz channel in a Wi-Fi 6 network. Line 802 shows the success rate using a static QoS network design approach, in which all autonomous devices request high QoS at all times to protect against worst case. It can be observed that six belts (e.g., the conveyer belt 706 of FIG. 7) may exceed the capacity of the network, so the necessary QoS cannot be delivered by the network and the tasks fail. The line 804 demonstrates that, using a dynamic QoS policy as learned by the RL methodology described herein, the overall system capacity can be improved by prioritizing data packets that have higher QoS requests as given by their current state.

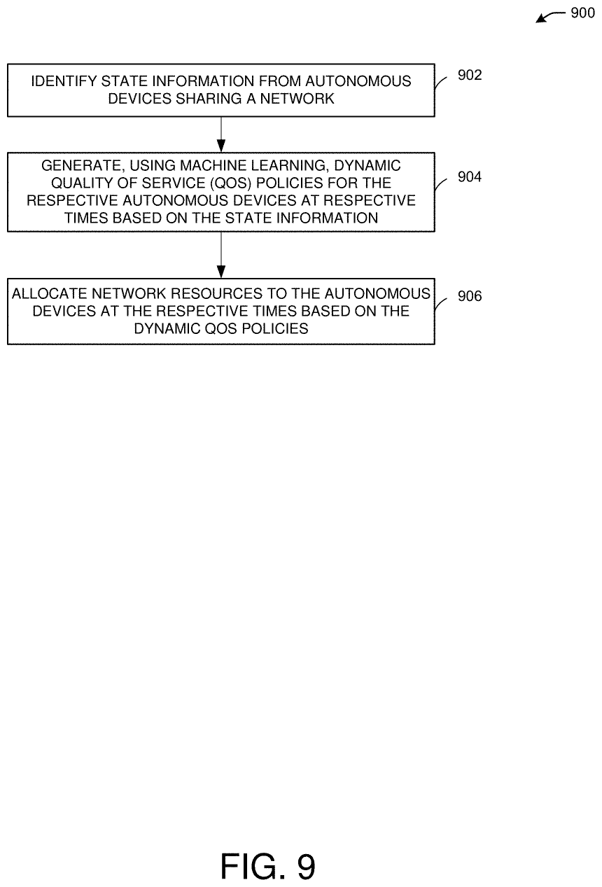

FIG. 9 illustrates a flow diagram of illustrative process 900 for an illustrative dynamic QoS system, in accordance with one or more example embodiments of the present disclosure.

At block 902, a device (e.g., the network edge 352 and/or the network 354 of FIG. 3, the edge processor 502 of FIG. 5, the edge/network scheduler of FIG. 6, the enhanced QoS device 1119 of FIG. 11) may identify state information of autonomous devices sharing a network. The autonomous devices may provide their state information to the device.

At block 904, the device may use multi-stage machine learning (e.g., FIG. 4) to generate a dynamic QoS specific to each autonomous device at a given time (e.g., the dynamic QoS for any device may change based on state information and network conditions). The dynamic QoS may use the equations above to minimize a network resource cost of the dynamic QoS for a respective device while still maintaining a minimum level of service needed for a respective device (e.g., the amount of network resources needed by a respective device at a given time).

At block 906, the device may allocate the network resources according to the dynamic QoS policies for the devices at a given time. As a result, bandwidth, channels, antennae, and the like may be allocated to the devices based on the dynamic QoS policies, which may be different than worst-case QoS policies for the network.

It is understood that the above descriptions are for purposes of illustration and are not meant to be limiting.

FIG. 10 shows a functional diagram of an exemplary communication station 1000, in accordance with one or more example embodiments of the present disclosure. In one embodiment, FIG. 10 illustrates a functional block diagram of a communication station that may be suitable for use as an AP 102 (FIG. 1) or a user device 120 (FIG. 1) in accordance with some embodiments. The communication station 1000 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1000 may include communications circuitry 1002 and a transceiver 1010 for transmitting and receiving signals to and from other communication stations using one or more antennas 1001. The communications circuitry 1002 may include circuitry that can operate the physical layer (PHY) communications and/or medium access control (MAC) communications for controlling access to the wireless medium, and/or any other communications layers for transmitting and receiving signals. The communication station 1000 may also include processing circuitry 1006 and memory 1008 arranged to perform the operations described herein. In some embodiments, the communications circuitry 1002 and the processing circuitry 1006 may be configured to perform operations detailed in the above figures, diagrams, and flows.

In accordance with some embodiments, the communications circuitry 1002 may be arranged to contend for a wireless medium and configure frames or packets for communicating over the wireless medium. The communications circuitry 1002 may be arranged to transmit and receive signals. The communications circuitry 1002 may also include circuitry for modulation/demodulation, upconversion/downconversion, filtering, amplification, etc. In some embodiments, the processing circuitry 1006 of the communication station 1000 may include one or more processors. In other embodiments, two or more antennas 1001 may be coupled to the communications circuitry 1002 arranged for sending and receiving signals. The memory 1008 may store information for configuring the processing circuitry 1006 to perform operations for configuring and transmitting message frames and performing the various operations described herein. The memory 1008 may include any type of memory, including non-transitory memory, for storing information in a form readable by a machine (e.g., a computer). For example, the memory 1008 may include a computer-readable storage device, read-only memory (ROM), random-access memory (RAM), magnetic disk storage media, optical storage media, flash-memory devices and other storage devices and media.

In some embodiments, the communication station 1000 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1000 may include one or more antennas 1001. The antennas 1001 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1000 may include one or more of a keyboard, a display, a non-volatile memory port, multiple antennas, a graphics processor, an application processor, speakers, and other mobile device elements. The display may be an LCD screen including a touch screen.

Although the communication station 1000 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1000 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1000 may include one or more processors and may be configured with instructions stored on a computer-readable storage device.

FIG. 11 illustrates a block diagram of an example of a machine 1100 or system upon which any one or more of the techniques (e.g., methodologies) discussed herein may be performed. In other embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environments. The machine 1100 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a power management device 1132, a graphics display device 1110, an alphanumeric input device 1112 (e.g., a keyboard), and a user interface (UI) navigation device 1114 (e.g., a mouse). In an example, the graphics display device 1110, alphanumeric input device 1112, and UI navigation device 1114 may be a touch screen display. The machine 1100 may additionally include a storage device (i.e., drive unit) 1116, a signal generation device 1118 (e.g., a speaker), a dynamic QoS device 1119, a network interface device/transceiver 1120 coupled to antenna(s) 1130, and one or more sensors 1128, such as a global positioning system (GPS) sensor, a compass, an accelerometer, or other sensor. The machine 1100 may include an output controller 1134, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1102 for generation and processing of the baseband signals and for controlling operations of the main memory 1104, the storage device 1116, and/or the dynamic QoS device 1119. The baseband processor may be provided on a single radio card, a single chip, or an integrated circuit (IC).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within the static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

The dynamic QoS device 1119 may carry out or perform any of the operations and processes (e.g., process 900) described and shown above.

It is understood that the above are only a subset of what the dynamic QoS device 1119 may be configured to perform and that other functions included throughout this disclosure may also be performed by the dynamic QoS device 119.

While the machine-readable medium 1122 is illustrated as a single medium, the term “machine-readable medium” may include a single medium or multiple media (e.g., a centralized or distributed database, and/or associated caches and servers) configured to store the one or more instructions 1124.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1100 and that cause the machine 1100 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1124 may further be transmitted or received over a communications network 1126 using a transmission medium via the network interface device/transceiver 1120 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1120 may include one or more physical jacks (e.g., Ethernet, coaxial, or phone jacks) or one or more antennas to connect to the communications network 1126. In an example, the network interface device/transceiver 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1100 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

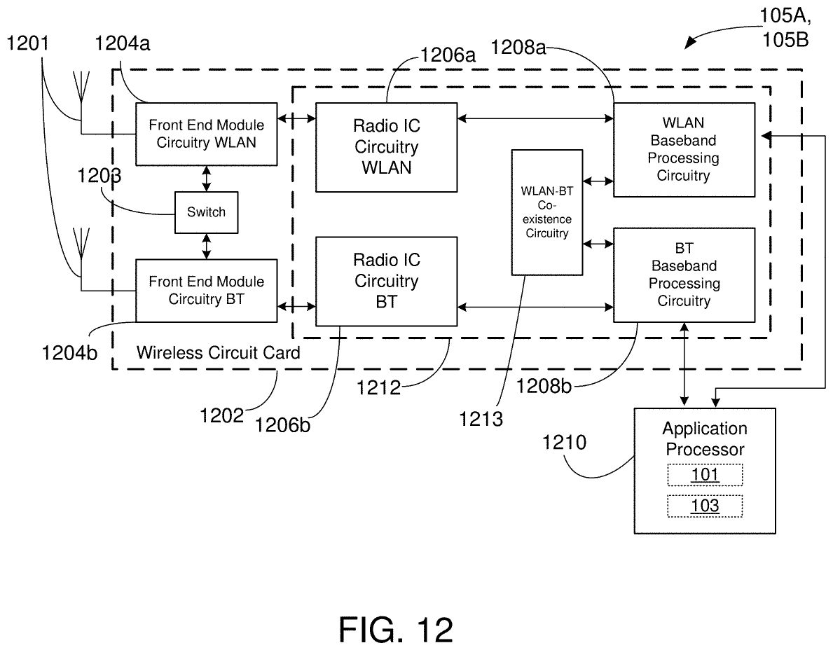

FIG. 12 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1204a-b, radio IC circuitry 1206a-b and baseband processing circuitry 1208a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1204a-b may include a WLAN or Wi-Fi FEM circuitry 1204a and a Bluetooth (BT) FEM circuitry 1204b. The WLAN FEM circuitry 1204a may include a receive signal path comprising circuitry configured to operate on WLAN RF signals received from one or more antennas 1201, to amplify the received signals and to provide the amplified versions of the received signals to the WLAN radio IC circuitry 1206a for further processing. The BT FEM circuitry 1204b may include a receive signal path which may include circuitry configured to operate on BT RF signals received from one or more antennas 1201, to amplify the received signals and to provide the amplified versions of the received signals to the BT radio IC circuitry 1206b for further processing. FEM circuitry 1204a may also include a transmit signal path which may include circuitry configured to amplify WLAN signals provided by the radio IC circuitry 1206a for wireless transmission by one or more of the antennas 1201. In addition, FEM circuitry 1204b may also include a transmit signal path which may include circuitry configured to amplify BT signals provided by the radio IC circuitry 1206b for wireless transmission by the one or more antennas. In the embodiment of FIG. 12, although FEM 1204a and FEM 1204b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1206a-b as shown may include WLAN radio IC circuitry 1206a and BT radio IC circuitry 1206b. The WLAN radio IC circuitry 1206a may include a receive signal path which may include circuitry to down-convert WLAN RF signals received from the FEM circuitry 1204a and provide baseband signals to WLAN baseband processing circuitry 1208a. BT radio IC circuitry 1206b may in turn include a receive signal path which may include circuitry to down-convert BT RF signals received from the FEM circuitry 1204b and provide baseband signals to BT baseband processing circuitry 1208b. WLAN radio IC circuitry 1206a may also include a transmit signal path which may include circuitry to up-convert WLAN baseband signals provided by the WLAN baseband processing circuitry 1208a and provide WLAN RF output signals to the FEM circuitry 1204a for subsequent wireless transmission by the one or more antennas 1201. BT radio IC circuitry 1206b may also include a transmit signal path which may include circuitry to up-convert BT baseband signals provided by the BT baseband processing circuitry 1208b and provide BT RF output signals to the FEM circuitry 1204b for subsequent wireless transmission by the one or more antennas 1201. In the embodiment of FIG. 12, although radio IC circuitries 1206a and 1206b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1208a-b may include a WLAN baseband processing circuitry 1208a and a BT baseband processing circuitry 1208b. The WLAN baseband processing circuitry 1208a may include a memory, such as, for example, a set of RAM arrays in a Fast Fourier Transform or Inverse Fast Fourier Transform block (not shown) of the WLAN baseband processing circuitry 1208a. Each of the WLAN baseband circuitry 1208a and the BT baseband circuitry 1208b may further include one or more processors and control logic to process the signals received from the corresponding WLAN or BT receive signal path of the radio IC circuitry 1206a-b, and to also generate corresponding WLAN or BT baseband signals for the transmit signal path of the radio IC circuitry 1206a-b. Each of the baseband processing circuitries 1208a and 1208b may further include physical layer (PHY) and medium access control layer (MAC) circuitry, and may further interface with a device for generation and processing of the baseband signals and for controlling operations of the radio IC circuitry 1206a-b.

Referring still to FIG. 12, according to the shown embodiment, WLAN-BT coexistence circuitry 1213 may include logic providing an interface between the WLAN baseband circuitry 1208a and the BT baseband circuitry 1208b to enable use cases requiring WLAN and BT coexistence. In addition, a switch 1203 may be provided between the WLAN FEM circuitry 1204a and the BT FEM circuitry 1204b to allow switching between the WLAN and BT radios according to application needs. In addition, although the antennas 1201 are depicted as being respectively connected to the WLAN FEM circuitry 1204a and the BT FEM circuitry 1204b, embodiments include within their scope the sharing of one or more antennas as between the WLAN and BT FEMs, or the provision of more than one antenna connected to each of FEM 1204a or 1204b.

In some embodiments, the front-end module circuitry 1204a-b, the radio IC circuitry 1206a-b, and baseband processing circuitry 1208a-b may be provided on a single radio card, such as wireless radio card 1202. In some other embodiments, the one or more antennas 1201, the FEM circuitry 1204a-b and the radio IC circuitry 1206a-b may be provided on a single radio card. In some other embodiments, the radio IC circuitry 1206a-b and the baseband processing circuitry 1208a-b may be provided on a single chip or integrated circuit (IC), such as IC 1212.

In some embodiments, the wireless radio card 1202 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1208b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

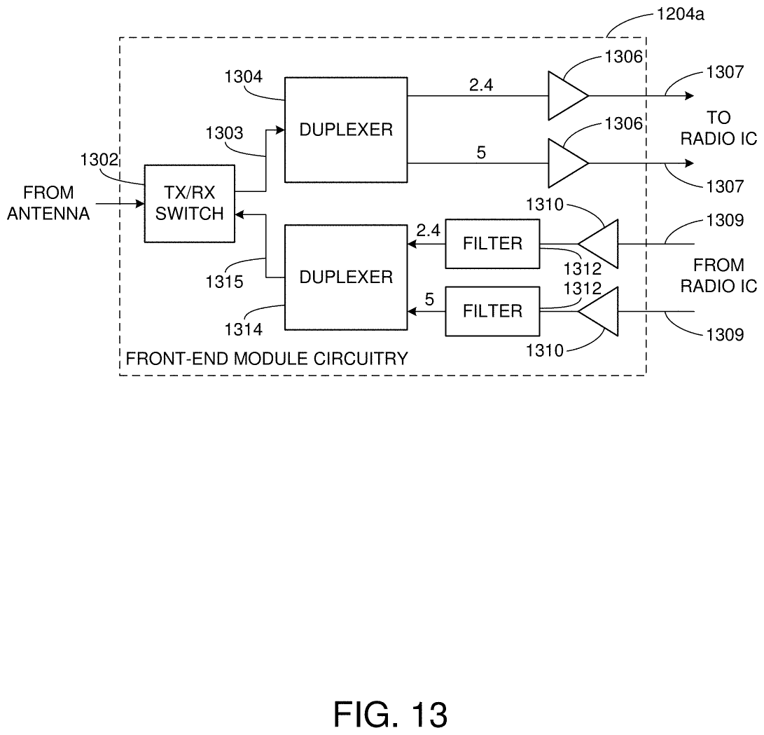

FIG. 13 illustrates WLAN FEM circuitry 1204a in accordance with some embodiments. Although the example of FIG. 13 is described in conjunction with the WLAN FEM circuitry 1204a, the example of FIG. 13 may be described in conjunction with the example BT FEM circuitry 1204b (FIG. 12), although other circuitry configurations may also be suitable.

In some embodiments, the FEM circuitry 1204a may include a TX/RX switch 1302 to switch between transmit mode and receive mode operation. The FEM circuitry 1204a may include a receive signal path and a transmit signal path. The receive signal path of the FEM circuitry 1204a may include a low-noise amplifier (LNA) 1306 to amplify received RF signals 1303 and provide the amplified received RF signals 1307 as an output (e.g., to the radio IC circuitry 1206a-b (FIG. 12)). The transmit signal path of the circuitry 1204a may include a power amplifier (PA) to amplify input RF signals 1309 (e.g., provided by the radio IC circuitry 1206a-b), and one or more filters 1312, such as band-pass filters (BPFs), low-pass filters (LPFs) or other types of filters, to generate RF signals 1315 for subsequent transmission (e.g., by one or more of the antennas 1201 (FIG. 12)) via an example duplexer 1314.

In some dual-mode embodiments for Wi-Fi communication, the FEM circuitry 1204a may be configured to operate in either the 2.4 GHz frequency spectrum or the 5 GHz frequency spectrum. In these embodiments, the receive signal path of the FEM circuitry 1204a may include a receive signal path duplexer 1304 to separate the signals from each spectrum as well as provide a separate LNA 1306 for each spectrum as shown. In these embodiments, the transmit signal path of the FEM circuitry 1204a may also include a power amplifier 1310 and a filter 1312, such as a BPF, an LPF or another type of filter for each frequency spectrum and a transmit signal path duplexer 1304 to provide the signals of one of the different spectrums onto a single transmit path for subsequent transmission by the one or more of the antennas 1201 (FIG. 12). In some embodiments, BT communications may utilize the 2.4 GHz signal paths and may utilize the same FEM circuitry 1204a as the one used for WLAN communications.

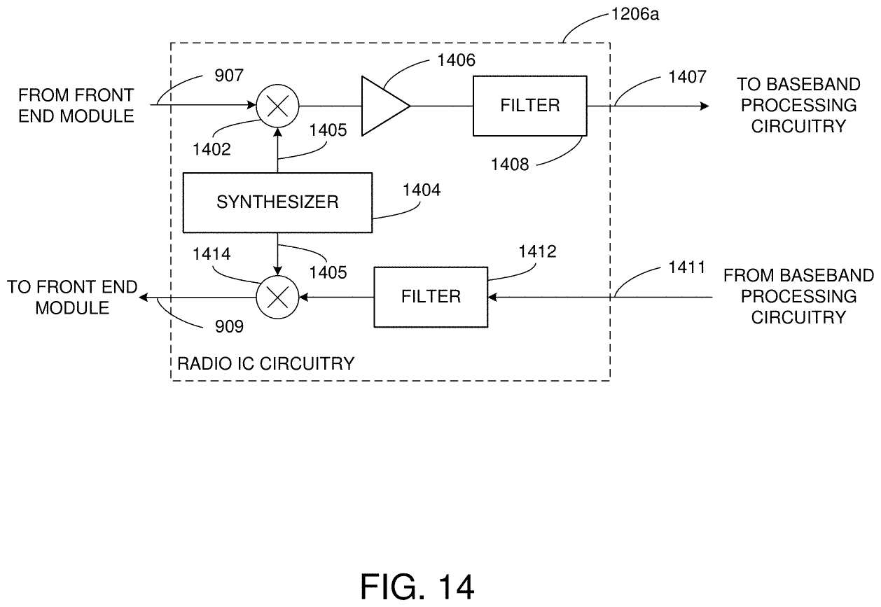

FIG. 14 illustrates radio IC circuitry 1206a in accordance with some embodiments. The radio IC circuitry 1206a is one example of circuitry that may be suitable for use as the WLAN or BT radio IC circuitry 1206a/1206b (FIG. 12), although other circuitry configurations may also be suitable. Alternatively, the example of FIG. 14 may be described in conjunction with the example BT radio IC circuitry 1206b.

In some embodiments, the radio IC circuitry 1206a may include a receive signal path and a transmit signal path. The receive signal path of the radio IC circuitry 1206a may include at least mixer circuitry 1402, such as, for example, down-conversion mixer circuitry, amplifier circuitry 1406 and filter circuitry 1408. The transmit signal path of the radio IC circuitry 1206a may include at least filter circuitry 1412 and mixer circuitry 1414, such as, for example, upconversion mixer circuitry. Radio IC circuitry 1206a may also include synthesizer circuitry 1404 for synthesizing a frequency 1405 for use by the mixer circuitry 1402 and the mixer circuitry 1414. The mixer circuitry 1402 and/or 1414 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 14 illustrates only a simplified version of a radio IC circuitry, and may include, although not shown, embodiments where each of the depicted circuitries may include more than one component. For instance, mixer circuitry 1414 may each include one or more mixers, and filter circuitries 1408 and/or 1412 may each include one or more filters, such as one or more BPFs and/or LPFs according to application needs. For example, when mixer circuitries are of the direct-conversion type, they may each include two or more mixers.

In some embodiments, mixer circuitry 1402 may be configured to down-convert RF signals 1307 received from the FEM circuitry 1204a-b (FIG. 12) based on the synthesized frequency 1405 provided by synthesizer circuitry 1404. The amplifier circuitry 1406 may be configured to amplify the down-converted signals and the filter circuitry 1408 may include an LPF configured to remove unwanted signals from the down-converted signals to generate output baseband signals 1407. Output baseband signals 1407 may be provided to the baseband processing circuitry 1208a-b (FIG. 12) for further processing. In some embodiments, the output baseband signals 1407 may be zero-frequency baseband signals, although this is not a requirement. In some embodiments, mixer circuitry 1402 may comprise passive mixers, although the scope of the embodiments is not limited in this respect.

In some embodiments, the mixer circuitry 1414 may be configured to up-convert input baseband signals 1411 based on the synthesized frequency 1405 provided by the synthesizer circuitry 1404 to generate RF output signals 1309 for the FEM circuitry 1204a-b. The baseband signals 1411 may be provided by the baseband processing circuitry 1208a-b and may be filtered by filter circuitry 1412. The filter circuitry 1412 may include an LPF or a BPF, although the scope of the embodiments is not limited in this respect.

In some embodiments, the mixer circuitry 1402 and the mixer circuitry 1414 may each include two or more mixers and may be arranged for quadrature down-conversion and/or upconversion respectively with the help of synthesizer 1404. In some embodiments, the mixer circuitry 1402 and the mixer circuitry 1414 may each include two or more mixers each configured for image rejection (e.g., Hartley image rejection). In some embodiments, the mixer circuitry 1402 and the mixer circuitry 1414 may be arranged for direct down-conversion and/or direct upconversion, respectively. In some embodiments, the mixer circuitry 1402 and the mixer circuitry 1414 may be configured for super-heterodyne operation, although this is not a requirement.

Mixer circuitry 1402 may comprise, according to one embodiment: quadrature passive mixers (e.g., for the in-phase (I) and quadrature phase (Q) paths). In such an embodiment, RF input signal 1307 from FIG. 14 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1405 of synthesizer 1404 (FIG. 14). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1307 (FIG. 13) may comprise a balanced signal, although the scope of the embodiments is not limited in this respect. The I and Q baseband output signals may be provided to low-noise amplifier, such as amplifier circuitry 1406 (FIG. 14) or to filter circuitry 1408 (FIG. 14).

In some embodiments, the output baseband signals 1407 and the input baseband signals 1411 may be analog baseband signals, although the scope of the embodiments is not limited in this respect. In some alternate embodiments, the output baseband signals 1407 and the input baseband signals 1411 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1404 may be a fractional-N synthesizer or a fractional N/N+1 synthesizer, although the scope of the embodiments is not limited in this respect as other types of frequency synthesizers may be suitable. For example, synthesizer circuitry 1404 may be a delta-sigma synthesizer, a frequency multiplier, or a synthesizer comprising a phase-locked loop with a frequency divider. According to some embodiments, the synthesizer circuitry 1404 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1404 may be provided by a voltage controlled oscillator (VCO), although that is not a requirement. A divider control input may further be provided by either the baseband processing circuitry 1208a-b (FIG. 12) depending on the desired output frequency 1405. In some embodiments, a divider control input (e.g., N) may be determined from a look-up table (e.g., within a Wi-Fi card) based on a channel number and a channel center frequency as determined or indicated by the example application processor 1210. The application processor 1210 may include, or otherwise be connected to, one of the example secure signal converter 101 or the example received signal converter 103 (e.g., depending on which device the example radio architecture is implemented in).

In some embodiments, synthesizer circuitry 1404 may be configured to generate a carrier frequency as the output frequency 1405, while in other embodiments, the output frequency 1405 may be a fraction of the carrier frequency (e.g., one-half the carrier frequency, one-third the carrier frequency). In some embodiments, the output frequency 1405 may be a LO frequency (fLO).

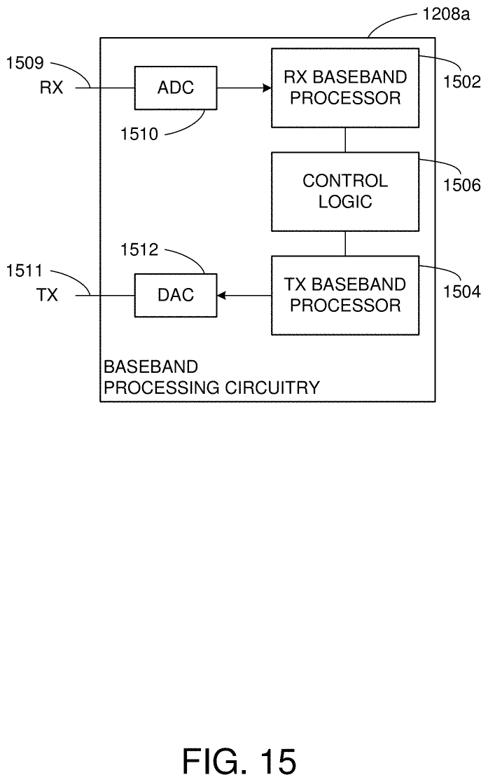

FIG. 15 illustrates a functional block diagram of baseband processing circuitry 1208a in accordance with some embodiments. The baseband processing circuitry 1208a is one example of circuitry that may be suitable for use as the baseband processing circuitry 1208a (FIG. 12), although other circuitry configurations may also be suitable. Alternatively, the example of FIG. 14 may be used to implement the example BT baseband processing circuitry 1208b of FIG. 12.

The baseband processing circuitry 1208a may include a receive baseband processor (RX BBP) 1502 for processing receive baseband signals 1409 provided by the radio IC circuitry 1206a-b (FIG. 12) and a transmit baseband processor (TX BBP) 1504 for generating transmit baseband signals 1411 for the radio IC circuitry 1206a-b. The baseband processing circuitry 1208a may also include control logic 1506 for coordinating the operations of the baseband processing circuitry 1208a.

In some embodiments (e.g., when analog baseband signals are exchanged between the baseband processing circuitry 1208a-b and the radio IC circuitry 1206a-b), the baseband processing circuitry 1208a may include ADC 1510 to convert analog baseband signals 1509 received from the radio IC circuitry 1206a-b to digital baseband signals for processing by the RX BBP 1502. In these embodiments, the baseband processing circuitry 1208a may also include DAC 1512 to convert digital baseband signals from the TX BBP 1504 to analog baseband signals 1511.

In some embodiments that communicate OFDM signals or OFDMA signals, such as through baseband processor 1208a, the transmit baseband processor 1504 may be configured to generate OFDM or OFDMA signals as appropriate for transmission by performing an inverse fast Fourier transform (IFFT). The receive baseband processor 1502 may be configured to process received OFDM signals or OFDMA signals by performing an FFT. In some embodiments, the receive baseband processor 1502 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 12, in some embodiments, the antennas 1201 (FIG. 12) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1201 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device of a network for providing dynamic quality of service (QoS) to multiple devices using QoS-aware controls, the device comprising processing circuitry coupled to storage, the processing circuitry configured to: identify first state information received from a first device using the network; identify second state information received from a second device using the network, the first state information and the second state information received using a wireless communication medium shared by the first device and the second device; generate, using machine learning, based on the first state information, a first dynamic QoS to be applied to the first device at a first time, wherein the first dynamic QoS minimizes a network resource cost function of the first dynamic QoS while providing a first allocation of resources needed by the first device at the first time; generate, using the machine learning, based on the second state information, a second dynamic QoS to be applied to the second device at the first time, wherein the second dynamic QoS minimizes a network resource cost function of the second dynamic QoS while providing a second allocation of resources needed by the second device at the first time; allocate the first allocation of resources to the first device, based on the first dynamic QoS, at the first time; and allocate the second allocation of resources to the second device, based on the second dynamic QoS, at the first time.

Example 2 may include the device of example 1 and/or any other example herein, wherein the processing circuitry is further configured to: generate, using the machine learning, a third dynamic QoS to be applied to the first device at a second time, wherein the third dynamic QoS minimizes a network resource cost function of the third dynamic QoS while providing a third allocation of resources needed by the first device at the second time; generate, using the machine learning, a fourth dynamic QoS to be applied to the second device at the second time, wherein the fourth dynamic QoS minimizes a network resource cost function of the fourth dynamic QoS while providing a fourth allocation of resources needed by the second device at the second time; allocate the third allocation of resources to the first device, based on the third dynamic QoS, at the second time; and allocate the fourth allocation of resources to the second device, based on the fourth dynamic QoS, at the second time.

Example 3 may include the device of example 1 and/or any other example herein, wherein the first dynamic QoS minimizes a network resource cost of the first device operating in a first state at the first time, wherein the first state information is indicative of the first state, wherein the second dynamic QoS minimizes a network resource cost of the second device operating in a second state at the first time, and wherein the second state information is indicative of the second state.

Example 4 may include the device of example 1 and/or any other example herein, wherein the machine learning comprises a first stage configured to learn a first ideal control policy for the first device using network conditions with no packet loss or delay, and to learn a second ideal control policy for the second device using network conditions with no packet loss or delay.

Example 5 may include the device of example 4 and/or any other example herein, wherein the machine learning further comprises a second stage configured to estimate, using reinforcement learning or supervised learning, a first current state of the first device at the first time based on the first state information, network latency, and network reliability, and a second current state of the second device at the first time based on the second state information, the network latency, and the network reliability, wherein the network latency and the network reliability are based on samples of states of the first device and the second device.

Example 6 may include the device of example 5 and/or any other example herein, wherein the machine learning further comprises a third stage configured to minimize, using reinforcement learning, the network resource cost function of the first dynamic QoS while providing the first allocation of resources needed by the first device at the first time and to minimize, using reinforcement learning, the network resource cost function of the second dynamic QoS while providing the second allocation of resources needed by the second device at the first time.

Example 7 may include the device of example 6 and/or any other example herein, wherein the machine learning further comprises fourth stage configured to generate the first dynamic QoS and the second dynamic QoS using reinforcement learning.

Example 8 may include the device of example 1 and/or any other example herein, further comprising a transceiver configured to transmit and receive wireless signals comprising the first state information and the second state information.

Example 9 may include the device of example 8 and/or any other example herein, further comprising an antenna coupled to the transceiver to cause to send the first state information and the second state information.

Example 10 may include a non-transitory computer-readable medium storing computer-executable instructions which when executed by one or more processors of a device for providing dynamic quality of service (QoS) to multiple devices using QoS-aware controls result in performing operations comprising: identifying first state information received from a first device using a network; identifying second state information received from a second device using the network, the first state information and the second state information received using a wireless communication medium shared by the first device and the second device; generating, using machine learning, based on the first state information, a first dynamic QoS to be applied to the first device at a first time, wherein the first dynamic QoS minimizes a network resource cost function of the first dynamic QoS while providing a first allocation of resources needed by the first device at the first time; generating, using the machine learning, based on the second state information, a second dynamic QoS to be applied to the second device at the first time, wherein the second dynamic QoS minimizes a network resource cost function of the second dynamic QoS while providing a second allocation of resources needed by the second device at the first time; allocating the first allocation of resources to the first device, based on the first dynamic QoS, at the first time; and allocating the second allocation of resources to the second device, based on the second dynamic QoS, at the first time.

Example 11 may include the non-transitory computer-readable medium of example 10 and/or any other example herein, the operations further comprising: generate, using the machine learning, a third dynamic QoS to be applied to the first device at a second time, wherein the third dynamic QoS minimizes a network resource cost function of the third dynamic QoS while providing a third allocation of resources needed by the first device at the second time; generate, using the machine learning, a fourth dynamic QoS to be applied to the second device at the second time, wherein the fourth dynamic QoS minimizes a network resource cost function of the fourth dynamic QoS while providing a fourth allocation of resources needed by the second device at the second time; allocate the third allocation of resources to the first device, based on the third dynamic QoS, at the second time; and allocate the fourth allocation of resources to the second device, based on the fourth dynamic QoS, at the second time.

Example 12 may include the non-transitory computer-readable medium of example 10 and/or any other example herein, wherein the first dynamic QoS minimizes a network resource cost of the first device operating in a first state at the first time, wherein the first state information is indicative of the first state, wherein the second dynamic QoS minimizes a network resource cost of the second device operating in a second state at the first time, and wherein the second state information is indicative of the second state.

Example 13 may include the non-transitory computer-readable medium of example 10 and/or any other example herein, wherein the machine learning comprises a first stage configured to learn a first ideal control policy for the first device using network conditions with no packet loss or delay, and to learn a second ideal control policy for the second device using network conditions with no packet loss or delay.

Example 14 may include the non-transitory computer-readable medium of example 13 and/or any other example herein, wherein the machine learning further comprises a second stage configured to estimate, using reinforcement learning or supervised learning, a first current state of the first device at the first time based on the first state information, network latency, and network reliability, and a second current state of the second device at the first time based on the second state information, the network latency, and the network reliability, wherein the network latency and the network reliability are based on samples of states of the first device and the second device.

Example 15 may include the non-transitory computer-readable medium of example 14 and/or any other example herein, wherein the machine learning further comprises a third stage configured to minimize, using reinforcement learning, the network resource cost function of the first dynamic QoS while providing the first allocation of resources needed by the first device at the first time and to minimize, using reinforcement learning, the network resource cost function of the second dynamic QoS while providing the second allocation of resources needed by the second device at the first time.

Example 16 may include the non-transitory computer-readable medium of example 15 and/or any other example herein, wherein the machine learning further comprises fourth stage configured to generate the first dynamic QoS and the second dynamic QoS using reinforcement learning.

Example 17 may include a method for providing dynamic quality of service (QoS) to multiple devices using QoS-aware controls, the method comprising: identifying, by processing circuitry of a first device, first state information received from a second device using a network; identifying, by the processing circuitry, second state information received from a third device using the network, the first state information and the second state information received using a wireless communication medium shared by the second device and the third device; generating, by the processing circuitry, using machine learning, based on the first state information, a first dynamic QoS to be applied to the second device at a first time, wherein the first dynamic QoS minimizes a network resource cost function of the first dynamic QoS while providing a first allocation of resources needed by the second device at the first time; generating, by the processing circuitry, using the machine learning, based on the second state information, a second dynamic QoS to be applied to the third device at the first time, wherein the second dynamic QoS minimizes a network resource cost function of the second dynamic QoS while providing a second allocation of resources needed by the third device at the first time; allocating, by the processing circuitry, the first allocation of resources to the second device, based on the first dynamic QoS, at the first time; and allocating, by the processing circuitry, the second allocation of resources to the third device, based on the second dynamic QoS, at the first time.

Example 18 may include the method of example 17 and/or any other example herein, further comprising: generating, using the machine learning, a third dynamic QoS to be applied to the first device at a second time, wherein the third dynamic QoS minimizes a network resource cost function of the third dynamic QoS while providing a third allocation of resources needed by the first device at the second time; generating, using the machine learning, a fourth dynamic QoS to be applied to the second device at the second time, wherein the fourth dynamic QoS minimizes a network resource cost function of the fourth dynamic QoS while providing a fourth allocation of resources needed by the second device at the second time; allocating the third allocation of resources to the first device, based on the third dynamic QoS, at the second time; and allocating the fourth allocation of resources to the second device, based on the fourth dynamic QoS, at the second time.

Example 19 may include the method of example 17 and/or any other example herein, wherein the first dynamic QoS minimizes a network resource cost of the first device operating in a first state at the first time, wherein the first state information is indicative of the first state, wherein the second dynamic QoS minimizes a network resource cost of the second device operating in a second state at the first time, and wherein the second state information is indicative of the second state.

Example 20 may include the method of example 17 and/or any other example herein, wherein the machine learning comprises four stages and uses reinforcement learning.

Example 21 may include an apparatus comprising means for identifying first state information received from a device using a network; identifying second state information received from a second device using the network, the first state information and the second state information received using a wireless communication medium shared by the device and the second device; generating, using machine learning, based on the first state information, a first dynamic QoS to be applied to the device at a first time, wherein the first dynamic QoS minimizes a network resource cost function of the first dynamic QoS while providing a first allocation of resources needed by the second device at the first time; generating, using the machine learning, based on the second state information, a second dynamic QoS to be applied to the second device at the first time, wherein the second dynamic QoS minimizes a network resource cost function of the second dynamic QoS while providing a second allocation of resources needed by the second device at the first time; allocating the first allocation of resources to the device, based on the first dynamic QoS, at the first time; and allocating the second allocation of resources to the second device, based on the second dynamic QoS, at the first time.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device of a network for providing dynamic quality of service (QoS) to multiple devices using QoS-aware controls, the device comprising processing circuitry coupled to storage, the processing circuitry configured to:
identify first state information received from a first device using the network;
identify second state information received from a second device using the network, the first state information and the second state information received using a wireless communication medium shared by the first device and the second device;
generate, using machine learning, based on the first state information, a first dynamic QoS to be applied to the first device at a first time, wherein the first dynamic QoS minimizes a network resource cost function of the first dynamic QoS while providing a first allocation of resources needed by the first device at the first time;
generate, using the machine learning, based on the second state information, a second dynamic QoS to be applied to the second device at the first time, wherein the second dynamic QoS minimizes a network resource cost function of the second dynamic QoS while providing a second allocation of resources needed by the second device at the first time;
allocate the first allocation of resources to the first device, based on the first dynamic QoS, at the first time; and
allocate the second allocation of resources to the second device, based on the second dynamic QoS, at the first time.

2. The device of claim 1, wherein the processing circuitry is further configured to:
generate, using the machine learning, a third dynamic QoS to be applied to the first device at a second time, wherein the third dynamic QoS minimizes a network resource cost function of the third dynamic QoS while providing a third allocation of resources needed by the first device at the second time;
generate, using the machine learning, a fourth dynamic QoS to be applied to the second device at the second time, wherein the fourth dynamic QoS minimizes a network resource cost function of the fourth dynamic QoS while providing a fourth allocation of resources needed by the second device at the second time;
allocate the third allocation of resources to the first device, based on the third dynamic QoS, at the second time; and
allocate the fourth allocation of resources to the second device, based on the fourth dynamic QoS, at the second time.

3. The device of claim 1, wherein the first dynamic QoS minimizes a network resource cost of the first device operating in a first state at the first time, wherein the first state information is indicative of the first state, wherein the second dynamic QoS minimizes a network resource cost of the second device operating in a second state at the first time, and wherein the second state information is indicative of the second state.

4. The device of claim 1, wherein the machine learning comprises a first stage configured to learn a first ideal control policy for the first device using network conditions with no packet loss or delay, and to learn a second ideal control policy for the second device using network conditions with no packet loss or delay.

5. The device of claim 4, wherein the machine learning further comprises a second stage configured to estimate, using reinforcement learning or supervised learning, a first current state of the first device at the first time based on the first state information, network latency, and network reliability, and a second current state of the second device at the first time based on the second state information, the network latency, and the network reliability, wherein the network latency and the network reliability are based on samples of states of the first device and the second device.

6. The device of claim 5, wherein the machine learning further comprises a third stage configured to minimize, using reinforcement learning, the network resource cost function of the first dynamic QoS while providing the first allocation of resources needed by the first device at the first time and to minimize, using reinforcement learning, the network resource cost function of the second dynamic QoS while providing the second allocation of resources needed by the second device at the first time.

7. The device of claim 6, wherein the machine learning further comprises fourth stage configured to generate the first dynamic QoS and the second dynamic QoS using reinforcement learning.

8. The device of claim 1, further comprising a transceiver configured to transmit and receive wireless signals comprising the first state information and the second state information.

9. The device of claim 8, further comprising an antenna coupled to the transceiver to cause to send the first state information and the second state information.

10. A non-transitory computer-readable medium storing computer-executable instructions which when executed by one or more processors of a device for providing dynamic quality of service (QoS) to multiple devices using QoS-aware controls result in performing operations comprising:
identifying first state information received from a first device using a network;
identifying second state information received from a second device using the network, the first state information and the second state information received using a wireless communication medium shared by the first device and the second device;
generating, using machine learning, based on the first state information, a first dynamic QoS to be applied to the first device at a first time, wherein the first dynamic QoS minimizes a network resource cost function of the first dynamic QoS while providing a first allocation of resources needed by the first device at the first time;
generating, using the machine learning, based on the second state information, a second dynamic QoS to be applied to the second device at the first time, wherein the second dynamic QoS minimizes a network resource cost function of the second dynamic QoS while providing a second allocation of resources needed by the second device at the first time;
allocating the first allocation of resources to the first device, based on the first dynamic QoS, at the first time; and
allocating the second allocation of resources to the second device, based on the second dynamic QoS, at the first time.

11. The non-transitory computer-readable medium of claim 10, the operations further comprising:
generate, using the machine learning, a third dynamic QoS to be applied to the first device at a second time, wherein the third dynamic QoS minimizes a network resource cost function of the third dynamic QoS while providing a third allocation of resources needed by the first device at the second time;
generate, using the machine learning, a fourth dynamic QoS to be applied to the second device at the second time, wherein the fourth dynamic QoS minimizes a network resource cost function of the fourth dynamic QoS while providing a fourth allocation of resources needed by the second device at the second time;
allocate the third allocation of resources to the first device, based on the third dynamic QoS, at the second time; and
allocate the fourth allocation of resources to the second device, based on the fourth dynamic QoS, at the second time.

12. The non-transitory computer-readable medium of claim 10, wherein the first dynamic QoS minimizes a network resource cost of the first device operating in a first state at the first time, wherein the first state information is indicative of the first state, wherein the second dynamic QoS minimizes a network resource cost of the second device operating in a second state at the first time, and wherein the second state information is indicative of the second state.

13. The non-transitory computer-readable medium of claim 10, wherein the machine learning comprises a first stage configured to learn a first ideal control policy for the first device using network conditions with no packet loss or delay, and to learn a second ideal control policy for the second device using network conditions with no packet loss or delay.

14. The non-transitory computer-readable medium of claim 13, wherein the machine learning further comprises a second stage configured to estimate, using reinforcement learning or supervised learning, a first current state of the first device at the first time based on the first state information, network latency, and network reliability, and a second current state of the second device at the first time based on the second state information, the network latency, and the network reliability, wherein the network latency and the network reliability are based on samples of states of the first device and the second device.

15. The non-transitory computer-readable medium of claim 14, wherein the machine learning further comprises a third stage configured to minimize, using reinforcement learning, the network resource cost function of the first dynamic QoS while providing the first allocation of resources needed by the first device at the first time and to minimize, using reinforcement learning, the network resource cost function of the second dynamic QoS while providing the second allocation of resources needed by the second device at the first time.

16. The non-transitory computer-readable medium of claim 15, wherein the machine learning further comprises fourth stage configured to generate the first dynamic QoS and the second dynamic QoS using reinforcement learning.

17. A method for providing dynamic quality of service (QoS) to multiple devices using QoS-aware controls, the method comprising:
identifying, by processing circuitry of a first device, first state information received from a second device using a network;
identifying, by the processing circuitry, second state information received from a third device using the network, the first state information and the second state information received using a wireless communication medium shared by the second device and the third device;
generating, by the processing circuitry, using machine learning, based on the first state information, a first dynamic QoS to be applied to the second device at a first time, wherein the first dynamic QoS minimizes a network resource cost function of the first dynamic QoS while providing a first allocation of resources needed by the second device at the first time;
generating, by the processing circuitry, using the machine learning, based on the second state information, a second dynamic QoS to be applied to the third device at the first time, wherein the second dynamic QoS minimizes a network resource cost function of the second dynamic QoS while providing a second allocation of resources needed by the third device at the first time;
allocating, by the processing circuitry, the first allocation of resources to the second device, based on the first dynamic QoS, at the first time; and
allocating, by the processing circuitry, the second allocation of resources to the third device, based on the second dynamic QoS, at the first time.

18. The method of claim 17, further comprising:
generating, using the machine learning, a third dynamic QoS to be applied to the first device at a second time, wherein the third dynamic QoS minimizes a network resource cost function of the third dynamic QoS while providing a third allocation of resources needed by the first device at the second time;
generating, using the machine learning, a fourth dynamic QoS to be applied to the second device at the second time, wherein the fourth dynamic QoS minimizes a network resource cost function of the fourth dynamic QoS while providing a fourth allocation of resources needed by the second device at the second time;
allocating the third allocation of resources to the first device, based on the third dynamic QoS, at the second time; and
allocating the fourth allocation of resources to the second device, based on the fourth dynamic QoS, at the second time.

19. The method of claim 17, wherein the first dynamic QoS minimizes a network resource cost of the first device operating in a first state at the first time, wherein the first state information is indicative of the first state, wherein the second dynamic QoS minimizes a network resource cost of the second device operating in a second state at the first time, and wherein the second state information is indicative of the second state.

20. The method of claim 17, wherein the machine learning comprises four stages and uses reinforcement learning.
